(19) United States
(12) Patent Application Publication
(10) Pub. No.: US 2018/0131412 A1
(43) Pub. Date: May 10, 2018

(54) METHODS FOR INCREASING DATA COMMUNICATION BANDWIDTH BETWEEN WIRELESS POWER DEVICES

(71) Applicant: Integrated Device Technology, Inc., San Jose, CA (US)

(72) Inventors: David WILSON, Soquel, CA (US); Gustavo MEHAS, Mercer Island, WA (US); Detelin MARTCHOVSKY, Fremont, CA (US)

(73) Assignee: Integrated Device Technology, Inc.

(21) Appl. No.: 15/808,684

(22) Filed: Nov. 9, 2017

Related U.S. Application Data
(60) Provisional application No. 62/420,422, filed on Nov. 10, 2016.

(51) Int. Cl. H04B 5/00; H02J 50/10

(52) U.S. Cl. CPC H04B 5/0037; H04B 5/0012; H02J 50/10

(57) ABSTRACT

A wireless power system according to some embodiments includes a wireless power receiver, the wireless power receiver including a receiver coil, a communications device incorporated with the receiver coil, a receiver transceiver coupled to the receiver communications device, and a receiver processor coupled to the receiver transceiver; and a wireless power transmitter, the wireless power transmitter including a transmitter coil, a transmitter communications device incorporated with the transmitter coil, a transmitter transceiver coupled to the transmitter communications device, and a transmitter processor coupled to the transmitter transceiver, wherein communications data is transmitted between the receiver communications device and the transmitter communications device.

### RELATED APPLICATIONS

The present application claims priority to U.S. Provisional Application 62/420,422, filed on Nov. 10, 2016, which is herein incorporated by reference in its entirety.

### TECHNICAL FIELD

Embodiments of the present invention are related to wireless power systems and, specifically, to communications between wireless power devices.

### DISCUSSION OF RELATED ART

Mobile devices, for example smart phones and tablets, are increasingly using wireless power charging systems. Typically, a wireless power charging system includes a transmitter coil that is driven to produce a time-varying magnetic field and a receiver coil that is positioned relative to the transmitter coil to receive the power transmitted in the time-varying magnetic field. It is becoming increasingly important for the wireless devices to communicate data during the wireless power.

Therefore, there is a need to develop better communications between wireless devices in a wireless power system.

### SUMMARY

In accordance with some embodiments of the present invention, a wireless power system is provided. In some embodiments, a wireless power receiver includes a receiver coil, a communications device incorporated with the receiver coil, a transceiver coupled to the communications device, and a processor coupled to the transceiver.

A wireless power system according to some embodiments includes a wireless power receiver, the wireless power receiver including a receiver coil, a communications device incorporated with the receiver coil, a receiver transceiver coupled to the receiver communications device, and a receiver processor coupled to the receiver transceiver; and a wireless power transmitter, the wireless power transmitter including a transmitter coil, a transmitter communications device incorporated with the transmitter coil, a transmitter transceiver coupled to the transmitter communications device, and a transmitter processor coupled to the transmitter transceiver, wherein communications data is transmitted between the receiver communications device and the transmitter communications device.

These and other embodiments are further discussed below with respect to the following figures.

### BRIEF DESCRIPTION OF THE DRAWINGS

FIG. 1 illustrates a wireless power transmission system.

FIG. 2 illustrates wireless power transmission system with communications between a wireless transmitter and a wireless receiver according to some embodiments of the present invention.

FIGS. 3A and 3B illustrate a wireless receiver and a wireless transmitter, respectively, according to some embodiments of the present invention.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description and the accompanying drawings that illustrate inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

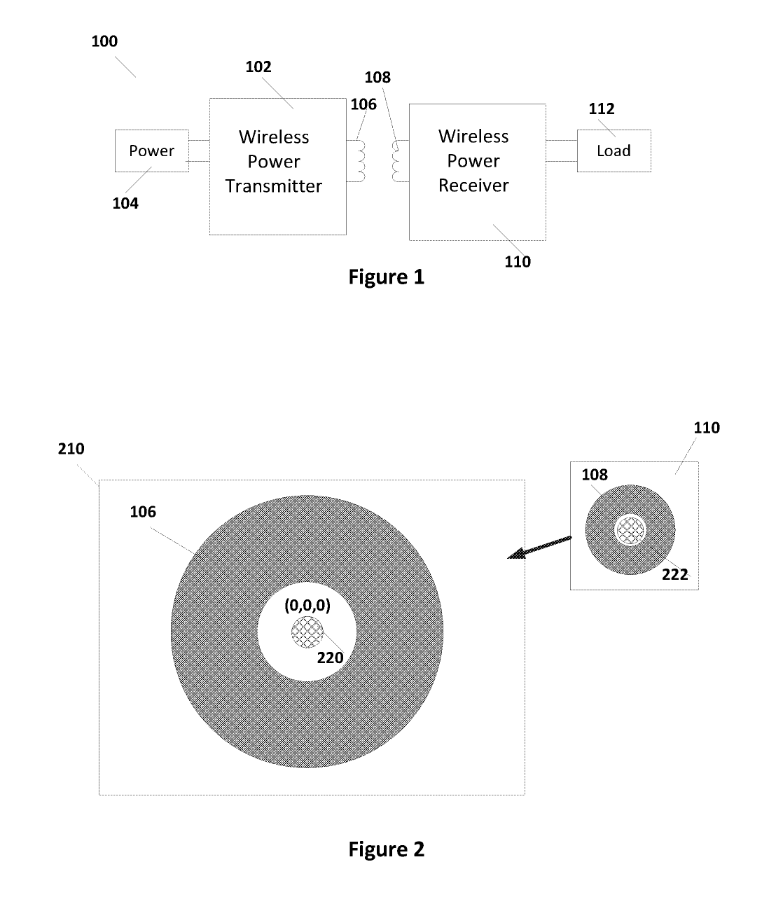

FIG. 1 illustrates a system 100 for wireless transfer of power. As illustrated in FIG. 1, a wireless power transmitter 102 drives a coil 106 to produce a magnetic field. A power supply 104 provides power to wireless power transmitter 102. Power supply 104 can be, for example, a battery based supply or may be powered by alternating current, for example 120V at 60 Hz. Wireless power transmitter 102 drives coil 106 at, typically, a range of frequencies according to one of the wireless power standards.

There are multiple standards for wireless transmission of power, including the Alliance for Wireless Power (A4WP) standard and the Wireless Power Consortium standard, the Qi Standard. Under the A4WP standard, for example, up to 50 watts of power can be inductively transmitted to multiple charging devices in the vicinity of coil 106 at a power transmission frequency of around 6.78 MHz. Under the Wireless Power Consortium, the Qi specification, a resonant inductive coupling system is utilized to charge a single device at the resonance frequency of the device. In the Qi standard, coil 108 is placed in close proximity with coil 106 while in the A4WP standard, coil 108 is placed near coil 106 along with other coils that belong to other charging devices. FIG. 1 depicts a generalized wireless power system 100 that operates under any of these standards.

As is further illustrated in FIG. 1, the magnetic field produced by coil 106 induces a current in coil 108, which results in power being received in a receiver 110. Receiver 110 receives the power from coil 108 and provides power to a load 112, which may be a battery charger and/or other components of a mobile device. Receiver 110 typically includes rectification to convert the received AC power to DC power for load 112.

Communications in many more conventional systems can be accomplished by modulating the power signal between transmitter coil 106 and receiver coil 108. However, the data rate available in this type of communication is low and the reliability is not high. Current AM and FM modulation methods used to transmit data between transmit coil 106 and receiver coil 108 tend to be limited to around 1-10 kBits/sec bandwidth. Consequently, data reliability is weak and subject to corruption while being supported by typically very limited error detection methods, for example such as by parity bit and checksum type methods. Various small tweaks have been made to these existing forward and back-channel communication methods. These tweaks, for example, may reduce the bit-time by half (simply by reducing the integration time, which also reduces signal-to-noise ratio (SNR)), reduce the frequency resolution (for back channel at the cost of requiring a bigger frequency deviation), and so-on.

However, none of these tweaks improve the communications channels sufficiently for current needs. Many applications require much higher data bandwidth between receiver and transmitter in one or both directions. Additionally, some applications (such as in automotive, industrial, or scientific applications) require much higher data reliability. Higher data bandwidths are also desired in cases that include requirements to have the need to know the health of a system, such as in a challenge/response type of communications.

In accordance with embodiments of the present invention, an additional communications channel is provided between transmitter 102 and power receiver 110. In some embodiments according to the present invention, communications are performed using separate carrier frequencies on transmitter coil 106 and receiver coil 108 that is unrelated to the power transmission signals. In some embodiments, a separate communications device can be added.

FIG. 1 further illustrates communications device 120 on transmitter 102 and corresponding communication device 122 on receiver 110. When receiver 110 is aligned with transmitter 102 such that transmitter coil 106 is aligned with receiver coil 108, communications device 120 is aligned with communications device 122. Device 120 and device 122 can, for example, correspond with transmitter coil 106 and receiver coil 108. In which case, communications can be, for example, through phase modulation of the wireless power signal, orthogonal frequency division multiplexing with a frequency well separated from that of the wireless power signal, discontinuous interruption of the wireless power, or frequency modulation. Each of these techniques is separated from the wireless power signal itself. In some cases, device 120 and device 122 are separate from and proximate to transmitter coil 106 and receiver coil 108. Device 120 and device 122 can, for example, be magnetic coils, magnetic coils positioned at a 90° orientation with transmit coil 106 and receiver coil 108, capacitive couplers, dipole antennas, ultrasonic or acoustic transducers, pressure transducers, or photodiodes. Other devices for communicating between transmitter 102 and receiver 110 can also be utilized.

A wireless power system according to some embodiments is further illustrated in FIG. 2. FIG. 2 illustrates an example of a power receiver 110 being positioned relative to a pad 210 that includes transmitter coil 106 and communications device 120. In some embodiments, communications device 120 can be positioned at the center of transmission coil 106 in pad 210. However, in some embodiments, communications device 120 can be provided adjacent to transmission coil 106.

As further illustrated in FIG. 2, receiver device 110 includes a similarly situated communications device 122. As shown in FIG. 2, communications device 122 is positioned in the center of receiver coil 108 such that when receiver coil 108 is positioned with respect to transmission coil 106 for efficient power transfer, communications device 120 of power transmitter 102 is also aligned with communications device 122 of receiver 110 to provide for communications between transmitter 102 and receiver 110. In some embodiments, communications can occur between transmitter 102 and receiver 110 over a short distance, for example up to 10 cm. However, in some cases as much as 20 cm of separation distance can be used.

In some embodiments, communications device 120 may be transmitter coil 106 and communications device 120 may be receiver coil 108. However, in some embodiments communications device 120 may be separate from transmitter coil 106 and receiver coil 108 may be separate from communications device 122.

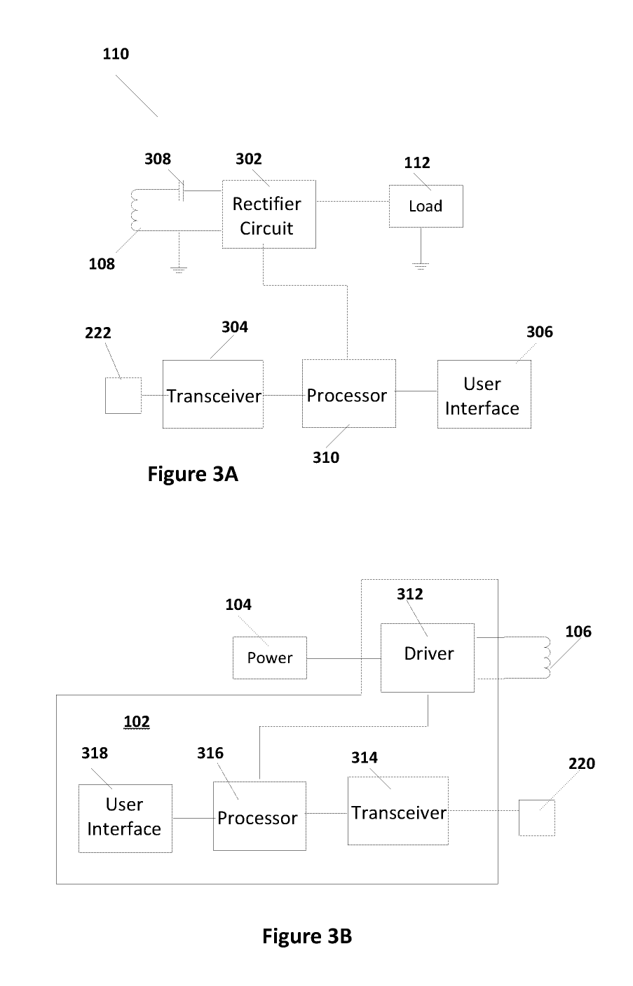

FIGS. 3A and 3B illustrates an example receiver device 110 and transmitter device 102 according to some embodiments of the invention. Various methods of communication can be used. The focus is on data transfer between receiver 110 and transmitter 102 using magnetic, capacitive, acoustical, or optical coupling (either in-band or out-of-band), and using structures that are already present or relationships that are inherent in the topology of the power transfer arrangement. Radio and ultrasound methods that take advantage of the topological relationships inherent in magnetic power delivery with regard to the relative positioning of transmitter coil 106 and receiver coil 108 are presented. Embodiment of the present invention are not independent of the positioning of receiver coil 108 with respect to transmitter coil 106 and therefore do not include the complexity inherent in Bluetooth radio or other concentric independent coils solely for communication and not dependent on the relative alignment of receiver 110 and transmitter 102, which involves substantial cost and complexity that work with a fully external parallel path.

As illustrated in FIG. 3A, receiver 110 includes a rectifier circuit 302 capacitively coupled through capacitor 308 to receive power from receiver coil 108 and provide power to a load 112. As illustrated in FIG. 3A, communications device 122 is coupled with a transceiver 304 to receive and send communications data from transmitter 102. Communications device 122 is a device that transmits and receives communications data. In some embodiments, communications device 122 can be receiver coil 108 and in some embodiments communications device 122 can be a separate device. Transceiver 304 is any circuit that receives data signals from or provides data signals to communications device 122.

In some embodiments, a processor 310 can be coupled to transceiver 304 to transmit or receive data from communications device 122. In some embodiments, processor 310 may also be coupled to a user interface 306. Processor 310 may include both volatile and non-volatile memory and one or more processors that execute instructions held in memory to control receiver device 110 and receive and transmit data through transceiver 304, although processor 310 may also be any circuit that provides data to and/or receives data from transceiver 304. Processor 310 may also be coupled to rectifier circuit 302 to affect the receipt of power through receiver coil 108.

FIG. 3B illustrates an example of transmitter 102. As is illustrated in FIG. 3B, transmitter 102 includes a driver 312 coupled to supply current through transmitter coil 106. As shown in FIG. 3B, communications device 120 is coupled to a transceiver 314. Communications device 120 may be transmitter coil 106. Transceiver 314 is any circuit that provides communications data signals and receives communications data signals through communications device 120. Processor 316 is coupled to exchange data with transceiver 314. Further, a user interface 318 may be coupled to processor 316. As discussed above, processor 316 may be any circuit that processes data and may include volatile and non-volatile memory as well as processors that execute instructions stored in memory to control driver 312 as well as to send and receive data through transceiver 314 and communications device 120.

Once the communications channel bandwidth is dramatically increased, then bandwidth becomes available for a wide range of already existing applicable error detection/correction methodologies, as well as very advanced system integrity and system health checking techniques.

In some embodiments, communications device 120 and 122 are transmitter coil 106 and receiver coil 108, respectively, and data is transmitted through phase modulation on the back channel to increase the bandwidth. In such embodiments, rectifier circuit 302 is a synchronous rectifier design for recovery of the phase modulated information. With a strong enough forcing function from driver 312, one or two bits of data per cycle of the power delivery signal may be possible. In the models illustrated in FIGS. 3A and 3B, communications devices 120 and 122 are transmit coils 106 and receive coil 108 respectively while transceiver 304 is combined with rectifier 302 and transceiver 314 is part of driver 312.

In a similar design, orthogonal frequency division multiplexing (OFDM) can be used to transmit data between transmitter coil 106 and receiver coil 108 using carrier frequencies not related to the transfer of power. Consequently, again communications device 120 is transmit coil 106 and communications device 122 is receive coil 108. Methods similar to OFDM are highly successful in data transfer over household AC wiring while delivering high bandwidth and high reliability in high noise environments and such methods can be used in communications in wireless power as well. OFDM and other methods are often coupled with advanced data reliability methods such as forward error correction. This is an out-of-band type method, but that is low energy owing to the complexity being in signal processing techniques and not forcing high energy events to deliver information.

In some embodiments, communications can be effected by creating intentional small but easily detectable discontinuities in the signal, for example from driver 312. In some embodiments, such a discontinuity can be provided by, for example, intentionally shorting the driver (e.g., driver 312) or reversing it for a short time. Other methods may also be used to provide for discontinuities as well. Providing discontinuities can be done sufficiently such that neither power loss nor electromotive interference (EMI) would be increased to where the application could be kept acceptable. These events are easily detectable at low cost on transceivers 304 and 314 by a variety of possible signal recovery techniques. These could be given some kind of “signature” so that they are distinguishable from potentially similar events such as reflecting of the load activity back into the wireless power system. Alternatively, there could be known or forced “quiet” times where the signal-to-noise ratio is made more favorable for higher bandwidth communications.

In some embodiments, existing FM techniques that enable much higher data rates than current implementations may be implemented at lower costs. These methods use some integration time at the receiver (e.g., transceiver 304 or transceiver 314) to reliably extract the frequency information which can be somewhat corrupted by unrelated system activity, shifting harmonic distortion, ringing, and so-on. In such embodiments, the ability of the receiving one of transceivers 304 or 314 to make rapid, high-resolution, high accuracy frequency measurements can be increased. However, in some embodiments, the extent to which the transmitter coil 106 and receiver coil 108 are in resonance may result in slower response from the system to some kind of forcing function to alter the frequency. One advantage of being able to make tiny but accurate frequency discriminations is that the forcing function can be proportionally smaller and the system response to clearly reflect the frequency change can be proportionally faster.

In some embodiments, combining voltage and current magnitude/phase information and optimizing bandwidth based upon measured signal-to-noise ratio (SNR) on both the receiver and transmitter side can increase the bandwidth. From this information, an optimized bandwidth and a modulation method can be determined. Error correction may be used when operating near the SNR limits. Similar to classical audio modem technologies, the channel can be studied and used adaptively.

Fundamentally, the most data can be transmitted with the least energy by placing this data where the SNR is greatest. This can be done both by studying the SNR of the available channel, and/or by designing the system such that inherently low noise channels are available by design that are used for data communication. In this scenario, the system dynamically places the information in channels with the most favorable SNR.

In some embodiments, capacitive coupling can be used rather than magnetic coupling to transfer information. In the lowest cost approach potentially the effective capacitance of the coils themselves could be used. In some embodiments, communications devices 120 and 122 can be a capacitive coupler. Much higher data rates and data reliability can potentially be achieved (bi-directional) in a more straightforward manner by including a capacitive pair of plates for communications devices 120 and 122. This is topologically favorable or even ideal by using the space in the center of the coil which is typically void of any coil windings. In this embodiment, the design of capacitive plates that have good capacitive coupling but interact minimally with the changing magnetic fields can be used. Methods for forming the capacitive plates such as slotting, serpentine arrays, etc. may be applicable. The idea can be extended by using a multiplicity of plates that can be arbitrarily small such that each plate pair constitutes a data channel, and therefore, potentially a large number of concurrent high bandwidth channels may be possible.

Some applications could benefit from a secondary coil-pair which are oriented orthogonal to the primary coil field. In such embodiments, communications devices 120 and 122 are communications coils oriented orthogonally to transmitter coil 106 and receiver coil 108, respectively. Such an arrangement enables magnetic coupled data transfer over a longer distance, but which is minimally interfered by energy or noise from the power transfer path formed by transmitter coil 106 and receiver coil 108. Such would be applicable in applications where the primary coil-coil distance is large enough that a communication coil pair could exist entirely in the gap.

In a similar embodiment, communication devices 120 and 122 may be dipole antennas positioned in the center of transmitter coil 106 and receiver coil 108, respectively, for short-distance radio communications. These embodiments can benefit from close-proximity radio communication that is physically integrated closely with the power transfer coils. For example, a small dipole antenna may be built into the center of the transmitter coils 106 and receiver coils 108. In some embodiments, RF coupling would be good, energy small, and SNR high. Although the cost of these embodiments may tend to be higher, there could be applications where it is advantageous topologically to have closely coupled RF links. Because of the contained environment, these embodiments may be exceptionally free from constraints of both electromagnetic emission requirements as well as electromagnetic immunity. So basically the scope of these embodiments would be in the physical environment between the power delivery coils.

Similar to above, communications devices 120 and 122 may use ultrasound or acoustic transducers of other frequencies as an alternate path. Such embodiments may confer valuable benefits in some applications. These transducers may be concentric with the coil structures and has advantages (compared to capacitive for example) of greater operating distance, along with immunity from electrical, electromagnetic, and magnetic inference.

In some embodiments, a sealed environment may be provided and communications devices 120 and 122 may be pressure transducers. Variable pressure may then be used for communication. This may not necessarily be a higher bandwidth technique, but instead may confer advantages of robustness over longer distance as compared with other methods.

In some embodiments, communications devices 120 and 122 may be photodiodes to transfer data optically between transmitter 102 and receiver device 110. Photodiodes may be placed in the centers of transmitter coil 106 and receiver coil 108. Alignment of communications devices 120 and 122 can be achieved when transmitter 102 and receiver device 110 are aligned for wireless power transfer.

The above detailed description is provided to illustrate specific embodiments of the present invention and is not intended to be limiting. Numerous variations and modifications within the scope of the present invention are possible. The present invention is set forth in the following claims.

What is claimed is:

1. A wireless power receiver, comprising:
a receiver coil;
a communications device incorporated with the receiver coil;
a transceiver coupled to the communications device; and
a processor coupled to the transceiver.

2. The wireless power receiver of claim 1, wherein the communications device is the receiver coil and communications data is provided through phase modulation.

3. The wireless power receiver of claim 1, wherein the communications device is the receiver coil and communications data is provided through orthogonal frequency division multiplexing using carrier frequencies unrelated to the transmission of power.

4. The wireless power receiver of claim 1, wherein the communications device is the receiver coil and communications data is provided through intentional discontinuities of the power signal.

5. The wireless power receiver of claim 1, wherein the communications device is the receiver coil and communications data is provided through frequency modulation.

6. The wireless power receiver of claim 1, wherein the communications device is the receiver coil and communications data is provided through combining voltage and current magnitude and phase information.

7. The wireless power receiver of claim 1, wherein communications data is provided through capacitive coupling.

8. The wireless power receiver of claim 1, wherein the communications device is a secondary coil positioned center to the receiver coil and oriented orthogonal to the receiver coil.

9. The wireless power receiver of claim 1, wherein the communications device is a dipole antenna positioned at the center of the receiver coil.

10. The wireless power receiver of claim 1, wherein the communications device is an ultrasonic or acoustic transducer.

11. The wireless power receiver of claim 1, wherein the communications device is a pressure transducer.

12. The wireless power receiver of claim 1, wherein the communications device is a photodiode.

13. A wireless power system, comprising:
a wireless power receiver, the wireless power receiver including a receiver coil, a receiver communications device incorporated with the receiver coil, a receiver transceiver coupled to the receiver communications device, and a receiver processor coupled to the receiver transceiver; and
a wireless power transmitter, the wireless power transmitter including a transmitter coil, a transmitter communications device incorporated with the transmitter coil, a transmitter transceiver coupled to the transmitter communications device, and a transmitter processor coupled to the transmitter transceiver,
wherein communications data is transmitted between the receiver communications device and the transmitter communications device.

14. The system of claim 13, wherein the receiver communication device and the transmitter communications device are aligned to exchange data when the receiver coil is aligned with the transmitter coil.

15. The system of claim 13, wherein the receiver communications device and the transmitter communications device are at least one of a set consisting of the receiver and transmit coils, capacitive couplers, data coils, data coils positioned orthogonally to the receiver and transmit coils, dipole antennas, pressure transducers, and photodiodes.

16. A wireless power transmitter, comprising:
a transmitter coil;
a transmitter communication device incorporated with the transmitter coil;
a transmitter transceiver coupled to the transmitter communication device; and
a transmitter processor coupled to the transmitter receiver.

17. The transmitter of claim 16, wherein the transmitter communication device is aligned with a receiver communication device when the transmitter coil is aligned with a receiver coil.

18. The transmitter of claim 16, wherein the transmitter communication devices is at least one of a set consisting of the receiver and transmit coils, capacitive couplers, data coils, data coils positioned orthogonally to the receiver and transmit coils, dipole antennas, pressure transducers, and photodiodes
